(19) United States
(12) Patent Application Publication
(10) Pub. No.: US 2012/0317061 A1
(43) Pub. Date: Dec. 13, 2012

(54) TIME ENCODING USING INTEGRATE AND FIRE SAMPLER

(76) Inventors: Choudur Lakshminarayan, Austin, TX (US); Alexander Singh Alvarado, Gainesville, FL (US); Jose C. Principe, Gainesville, FL (US)

(21) Appl. No.: 13/157,009

(22) Filed: Jun. 9, 2011

(51) Int. Cl. G06N 3/08

(52) U.S. Cl. 706/25

(57) ABSTRACT

Systems and methods of time encoding using an integrate and fire (IF) sampler are disclosed. In an example, a method includes receiving input signals for separate classes. The method also includes generating a pulse train based on the input signals. The method also includes binning the pulse train to generate a feature vector.

### BACKGROUND

Conventional analog to digital converters (ADC) represent a signal using a uniform sample set, which under the Nyquist constraint perfectly represents a band-limited function. Signal processors leverage this representation, and can operate on the samples directly. Nevertheless, there are input dependent encoders (also referred to as “adaptive samplers”) that also enable recovery. Unlike the conventional ADC, the location of the samples or domain is dependent on the input.

These adaptive samplers offer benefits over conventional ADC, for example in applications where only specific regions of the input are of interest. Furthermore, these adaptive samplers are simple in their construction, and therefore appropriate for applications with area and power constraints. One such example is encoding of action potentials (also referred to as “spikes”) overlaid over a low amplitude noisy background. An adaptive sampler can be used to achieve accurate reconstruction of the action potentials, while reducing the overall bandwidth to sub-Nyquist rates, because samples are only produced in the regions of high amplitude. Furthermore, the adaptive nature of the sampler can be extended to other characteristics of the input.

The main characteristic of these adaptive samplers is that information is encoded in the time between the samples. Time encoding schemes can be classified generally into two types. The first group uses time codes, which rely on knowledge of the precise timing of the samples, and usually operate near the Nyquist rate. The second type uses rate codes, which capture information in terms of the average sample rate. Moving from rate codes to time codes, the relationship between the samples and the continuous input changes from linear to nonlinear. Therefore, compression in the sampling stage comes at the cost of nonlinear recovery methods.

### BRIEF DESCRIPTION OF THE DRAWINGS

FIG. 1 is a high-level illustration of an example Intergrate and Fire (IF) sampler.

FIG. 2 shows an example binning process.

FIG. 3a-b show plots of actual action potentials for corresponding classes in an example.

FIGS. 4a-b shows each trial representing a single pulse train for the example of FIGS. 3a-b.

FIG. 5 is a plot showing distribution of the projections of two classes from FIGS. 4a-b when using a uniform sampler.

FIG. 6 is a plot showing example ROC curves at different sample rates for both the uniform and IF schemes.

FIG. 7 shows an example multi-channel IF system.

FIGS. 8 and 9 are flowcharts illustrating exemplary operations which may be implemented for time encoding using an integrate and fire sampler.

### DETAILED DESCRIPTION

Most signal processing efforts that use adaptive sampling schemes depend on reconstruction algorithms, in order to use the commercially available signal processors. For example, integrate and fire (IF) encoded neural signals can be reconstructed in order to detect and sort all action potentials. The systems and methods disclosed herein, however, work directly on the samples, avoiding the need for reconstruction algorithms. The systems and methods may be implemented in any of wide variety of applications (e.g., seismological, electro-cardiogram, traffic, weather, etc.) from a single source, or from multiple sources. Although not limited in application, the systems and methods may be implemented in wireless environments where bandwidth constraints may make other signal processing techniques difficult to implement.

In an example, the systems and methods described herein implement a time-based encoding scheme using the IF sampler. The IF samples include discriminative information. Hence, the IF sampler can operate directly on the samples, avoiding the conventional framework of sampling and reconstruction. In an example application, the IF sampler may be utilized to discriminate action potentials from two separate neurons, a common problem in current Brain Machine Interfaces (BMI). Discriminability, in terms of the classification error, can be determined on the projection of the samples by linear discriminant analysis. Results from this example show that the IF sampler preserves discriminability features of the input signal even at sub-Nyquist sampling rates. Furthermore, the IF encoding performs at least as well as uniform samplers at the same data rate.

Several difficulties arise, since the sample set for each input is likely to be different in terms of the number of samples and their locations. Therefore, the systems and methods described herein may use a carefully chosen embedding (or binning) scheme. Discriminability is used in terms of the classification error of a Linear Discriminant Analysis (LDA) classifier. Although these methods can be applied to any time-based sampler, the examples discussed herein are with reference to the IF sampler and its application to neural encoding.

The IF model has been extensively used in the computational neuroscience field to study the dynamics of neuron populations. Information in these large systems is encoded in the timing of the events, also referred to as spikes. The main approach in the study and analysis of these time-based codes assumes that these are realizations of a stochastic point process model. In this case, the output of the IF is considered a realization from a stochastic point process. The measure of similarity between two spike trains is given by the statistics of the generating point processes. A point process can be described by its conditional intensity function λ(t|Hₜ), where Hₜ denotes the history of the process until time t. The conditional intensity function defines the instantaneous rate of occurrence given all previous history. Nevertheless, since the conditional intensity function is conditioned on the entire history, the function cannot be estimated in practice, because the data is not available. Therefore, a typical assumption is that the conditional intensity function only depends on the current time and the time to the previous event t* such that:

λ(t|Hₜ)=λ(t,t−t*)

Furthermore, most Brain Machine Interfaces (BMI) rely on the estimate of the mean conditional intensity function as determined by averaging over the binned spike trains. The examples described herein also use binned vectors of the point process realizations as features.

A number of different similarity measures for spike train analysis are known, as well as comparisons between single realizations. Based on these similarity measures, clustering and classification algorithms can be implemented. The examples described herein are concerned with classification, since discriminability between two classes is shown in the encoded spike representation based on the classification error in this domain. Of course, similarity measures do not describe the classification error. However, mutual information can be used as a bound on the classification error by Fano's inequality. However, Fano's inequality can be difficult to estimate in practice, given the amount of data needed. Therefore, in another example the performance of the LDA classifier may be used as a measure of discriminability.

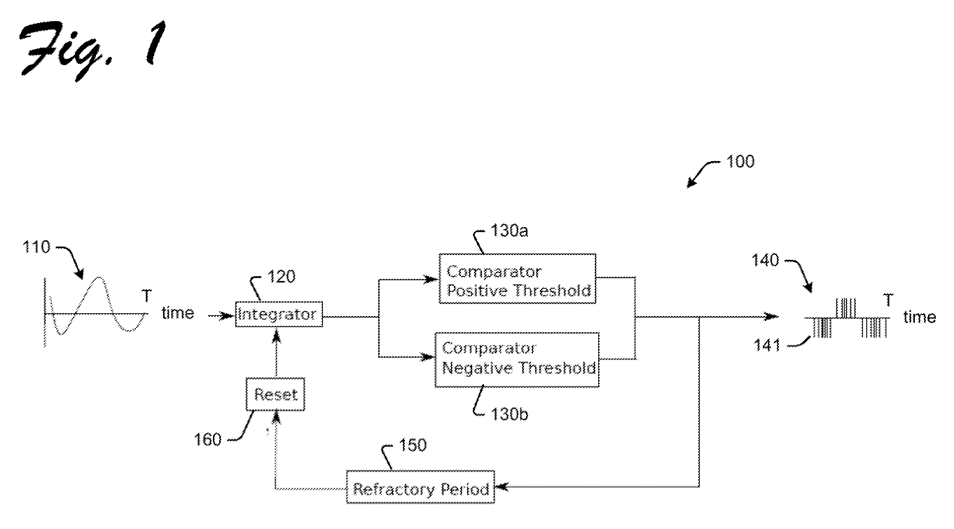

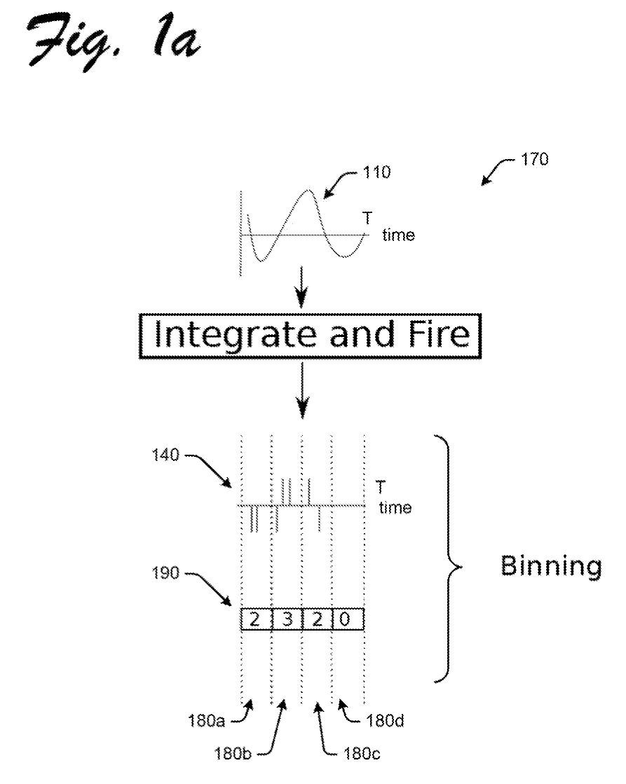

FIG. 1 is a high-level illustration of an example IF sampler 100. In this example, a continuous input 110 is received by the integrator 120. Here, the input x(t) is integrated with an averaging function u(t) from a starting time t₀ until the integral reaches a value specified by either threshold 130a (+θ) or 130b (−θ). At that instant, an individual spike or pulse is generated with a polarity corresponding to the specific threshold crossed. Multiple pulses 141 are shown in FIG. 1 comprising a pulse train 140.

In order that two pulses are not generated too close together in the pulse train 140, the IF sampler 100 may wait for a predetermined time (also referred to as a refractory period 150). Then, the integrator 120 is reset 160 to zero and the process repeats.

The output from this process includes a non-uniformly distributed set of events referred to herein as the pulse train 140. The pulse train 140 can be determined recursively, assuming a starting time t₀ such that:

∫ₜ_{ₖ}^{t}^{ₖ₊₁}x(t)u(t)dt=qₖ
where qₖε{−θ,θ}

In contrast to conventional sampling schemes, the IF samples not only provide linear constraints on the input, but also constrain the variation of its integral between samples, given that if the value had surpassed the threshold then another sample would be created. However, perfect recovery of the sampled function is not as important as the correct classification in the sampled space. Instead, the parameters are considered to define features that are extracted from the input signal. Therefore, the parameters are reduced to only the threshold. That is, the averaging function ‘u’ is set to unity and the encoded representation includes sufficient information to discriminate both classes.

To classify the encoded signals, the feature space is first defined to describe the samples. In this example, the feature space includes binning the data and creating a vector with the sample counts (also known as the firing rate).

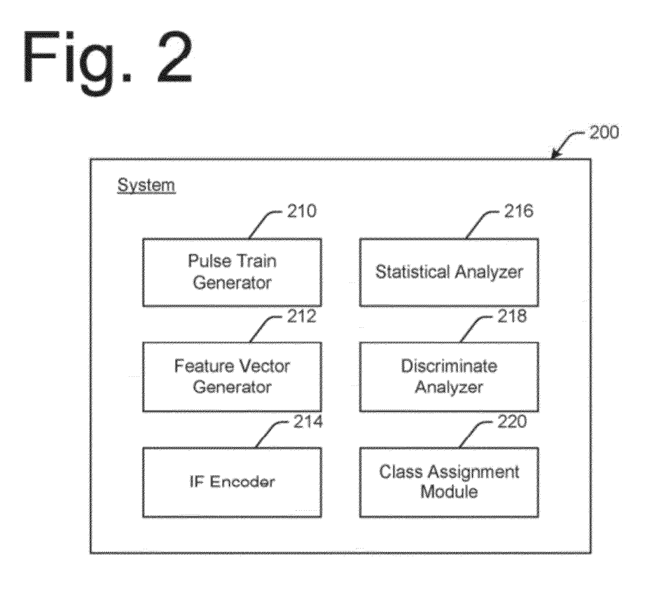

FIG. 1a shows an example binning process 170. Continuous input 110 is put through the IF process to output a pulse train 140, as described above for FIG. 1. The pulse train 140 is then divided into equal size bins 180a-d. Then the number of pulses 141 (or events) that fall within each interval or bin 180a-d are counted. In FIG. 2, the first bin 180a includes 2 pulses and is assigned the number “2”, the second bin 180b includes 3 pulses (including both positive and negative pulses) and is assigned the number “3”, and so forth. The corresponding output from the binning process is shown by reference 190.

It is noted that any number of bins may be used. Determining the number of bins may be estimated. However, if the input is band-limited, and the IF sampling rate is near Nyquist, the bin size may be determined in relation to the maximum input frequency.

The feature vectors may be derived from the original input series for two signal classes. LDA may be used to distinguish between the classes. In this example with two-class classification, LDA allows a feature vector to be assigned to a given class by maximizing the posterior probability of classification, or expected cost of misclassification. In this example, the optimal projection vector is chosen such that the vector maximizes separability between the class means and minimizes the class spread in the projected space, where the summation is obtained by pooling the covariance matrices of the two classes. LDA assumes that the distribution of the feature vector is multivariate Normal.

The IF encoding preserves discriminative features of the input classes. In an example, the inputs are neural action potentials over a period of 2 milliseconds that have been sorted by an expert. Although action potentials are in general similar, the geometry of the recording setup induces distortions in the shapes. This distortion allows grouping the action potentials.

FIG. 2 shows an example of a system 200 for time encoding using an integrate and fire sampler. In an example, the system 200 may be implemented with a computer readable medium and a processor, the processor executing program code stored on the computer readable medium for time encoding using an integrate and fire sampler.

An example of the system 200 is shown in FIG. 2 as it may be implemented in machine readable instructions. The machine readable instructions are shown for purposes of illustration as modules. It is noted, however, that the program code need not be implemented as modules.

In the example shown in FIG. 2, system 200 may include a pulse train generator 210 to generate a pulse train based on the input signals for separate classes. The system 200 may also include a feature vector generator 212 to bin the pulse train and generate a feature vector.

The system 200 may also include an IF encoder 214 to apply IF encoding to the input signals. The system 200 may also include a statistical analyzer 216 to determine first and second order statistics.

The system 200 may also include a discriminate analyzer 218 to apply discriminate analysis. The system 200 may also include a class assignment module 220 to determine class assignment based on class conditional probability densities.

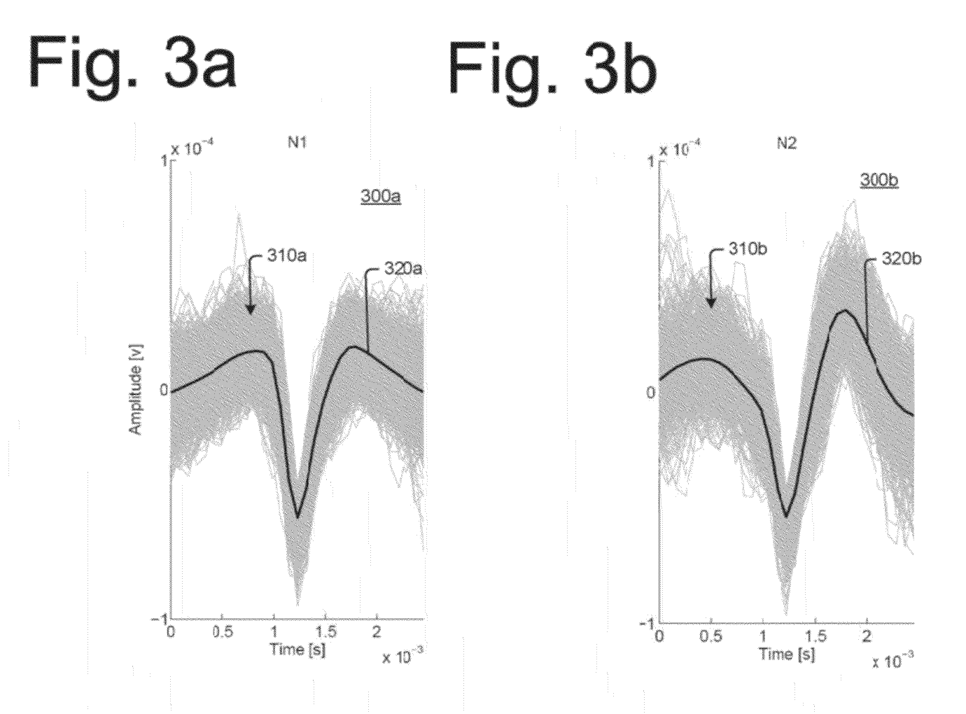

FIG. 3a-b show plots 300a and 300b of actual action potentials for corresponding classes in an example. In this example, each voltage trace 310a and 310b corresponds to a single realization with the average of the realizations shown by 320a and 320b. The bandwidth for neural recordings is typically set at 5 Khz, and so in this example the sampling rate was nearly 12,000 samples per second. To generate the IF samples, the input was up-sampled by a factor of 50 to reduce the timing quantization of the samples. Each of these segments was then encoded through the IF sampler.

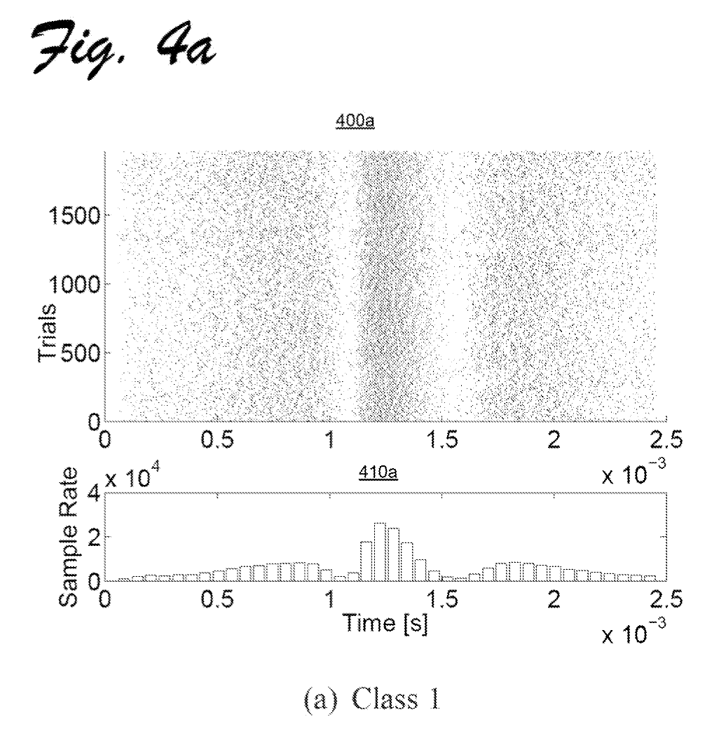

Each trial is shown in FIGS. 4a-b, representing a single pulse train. In FIGS. 4a-b, a single pulse train is shown as a single row in plots 400a and 400b. Colors may be used to encode the polarity of the pulses (e.g., red representing negative and black representing positive). However, in the black and white representation shown in FIGS. 4a-b, negative pulses are on the outer limits of the plots, while positive pulses are shown clustered near the middle section of the plot.

The plots 410a and 410b show the mean firing rate estimated by binning each realization. For example, mean firing rate may be determined by counting the number of events in each bin and averaging over all trials. It is noted that in this example the polarity of the pulses is ignored.

The time based encoding provided by the IF can be compared to a conventional uniform sampler. In order to show discriminability the classification error from the LDA-based classifier is used. In other words, two different feature representations are compared for the continuous input. The first uses a uniform sample distribution from the original signal. The second is based on IF encoding.

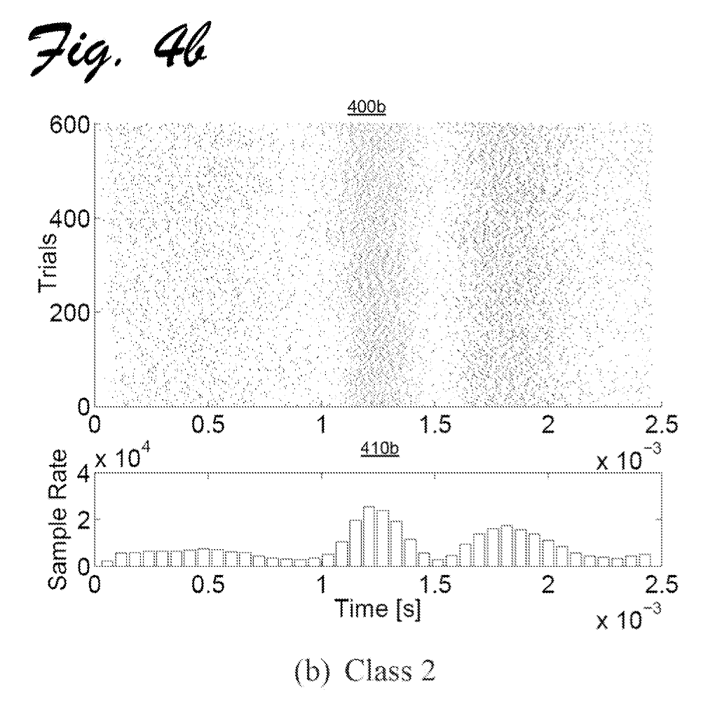

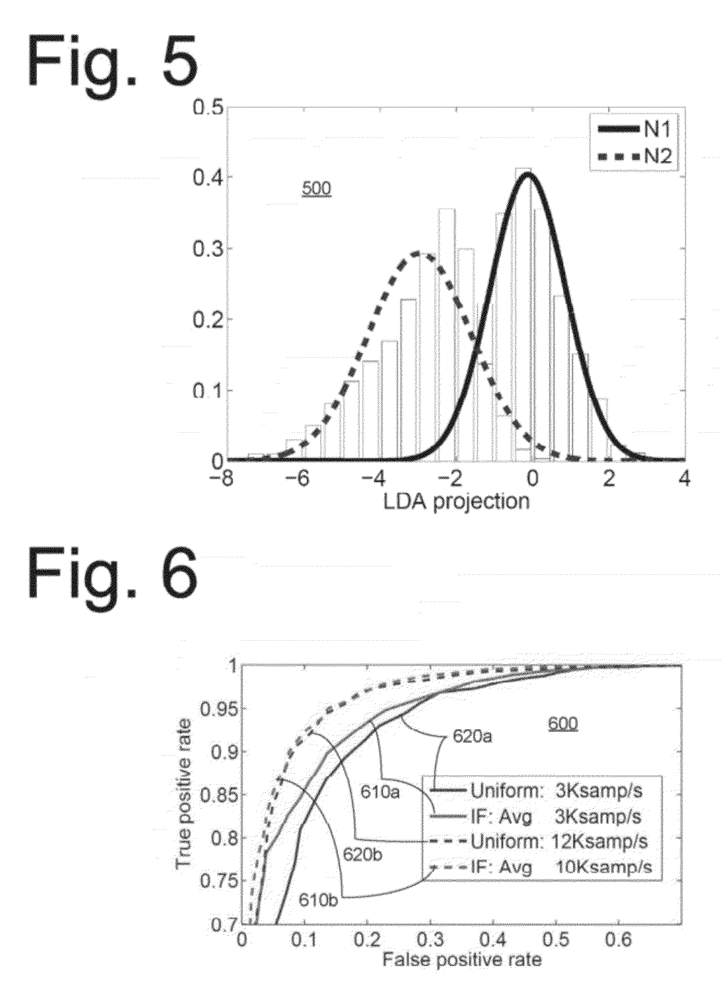

In this example, the features determined from the samples are projected onto a line, because LDA is being used and this is a two class problem. FIG. 5 is a plot 500 showing distribution of the projections of the two classes (N1 and N2) from FIGS. 4a-b when using a uniform sampler at about 30,000 samples per second (which is above the Nyquist rate of 10 KHz). The large “within class” variance causes the distribution of the two classes to overlap. It is noted that in this example the distributions were approximated by a Gaussian probability distribution function or density function.

The performance of the encoding for both samplers is presented over a range of decision boundaries given by Receiver Operating Characteristic (ROC) curves, which relate the true positive rates (TPR) and the false positive rates (FPR). FIG. 6 is a plot 600 showing example ROC curves at different sample rates. As can be seen in the figure, the IF features (plots 610a and 610b) outperform the conventional uniform sampler (plots 620a and 620b) at sample rates near the Nyquist boundary, and at lower rates. The improvement is greater as the sampler threshold increases. As the threshold increases the sample rate decreases.

Intuitively, the IF samples are placed in the discriminative regions between the two classes, which are related to high amplitude. The IF encoding not only provides discrimination in the sampled domain, but also does so at sub-Nyquist rates. In comparison to the conventional approach of reconstructing the input, IF together with binning over the samples retains important features of the input to provide discriminability between two signal classes.

The time-based encoding provided by the IF sampler conserves discriminative features of the neuron action potentials. Discriminability is measured in relation to the classification error using LDA. It is noted that in this example, the IF samples outperformed the uniform sampler, and the difference in the classification error increased as the sample rates decreased. Accordingly, time-encoding schemes can indeed carry discriminative features into the output domain.

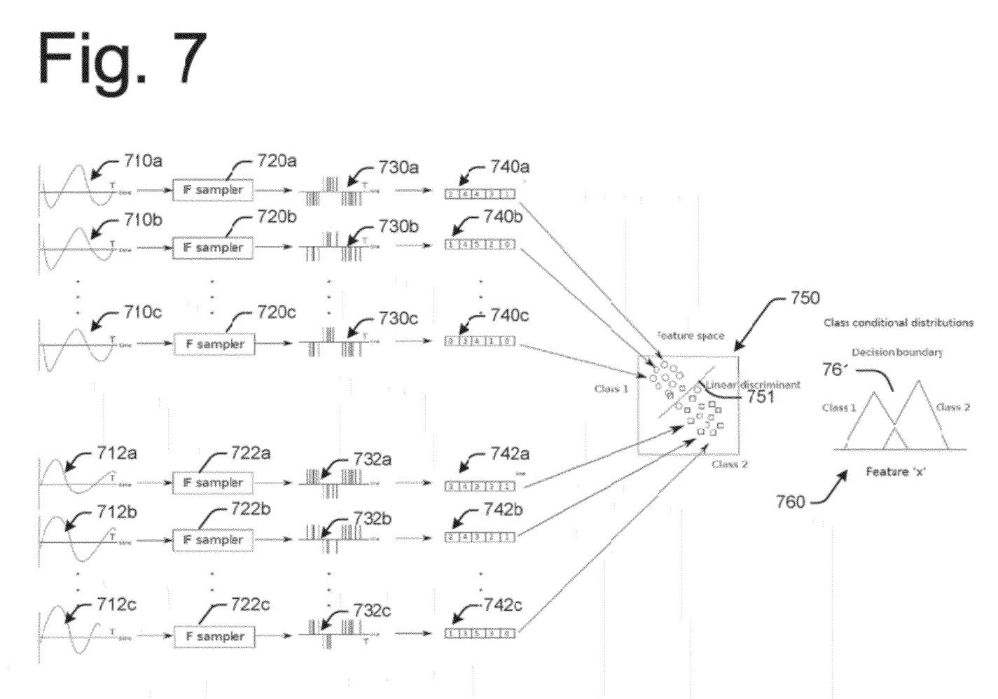

The approach described above may also be extended to multi-channel IF that implements multiple IF samplers. FIG. 7 shows an example multi-channel IF system 700. Continuous input 710a-c and 712a-c may be processed by the IF samplers 720a-c and 722a-c. Here, the input is integrated with an averaging function from a starting time t₀ until the integral reaches a value specified by either threshold, as described above in more detail. Individual pulses generate pulse trains 730a-c and 732a-c.

The pulse trains 730a-c and 732a-c are then divided into bins 740a-c and 742a-c. The corresponding output from the binning process can be used to generate a feature space 750.

The feature vectors may be derived from the original input series for two signal classes. LDA may be used to distinguish between the classes. In this example with two class classification, LDA allows a feature vector to be assigned to a given class (Class 1 or Class 2 in FIG. 7) by maximizing the posterior probability of classification, or expected cost of misclassification. In this example, the optimal projection vector is chosen such that the vector maximizes separability between the class means and minimizes the class spread in the projected space, where the summation is obtained by pooling the covariance matrices of the two classes. It can be seen by the class conditional distributions 760 in FIG. 7 that IF encoding preserves discriminative features of the input classes. It is noted that the data shown in FIG. 7 is example data and not actual test results.

Before continuing, it is noted that although the above examples are with reference to neural action potentials, the systems and methods described herein may be implemented with any suitable data sets and are not limited to any particular type of input. Nor are the systems and methods described herein limited to any particular number of input sources, or number of classes in the feature space. For example, five bins may be used to generate a five-dimensional feature space. Likewise, the “decision line” 751 shown in feature space 750 or corresponding “decision boundary” 761 shown in plot 760 need not be a line, but can also be a plane, curve, “zig-zag”, or any other discriminate.

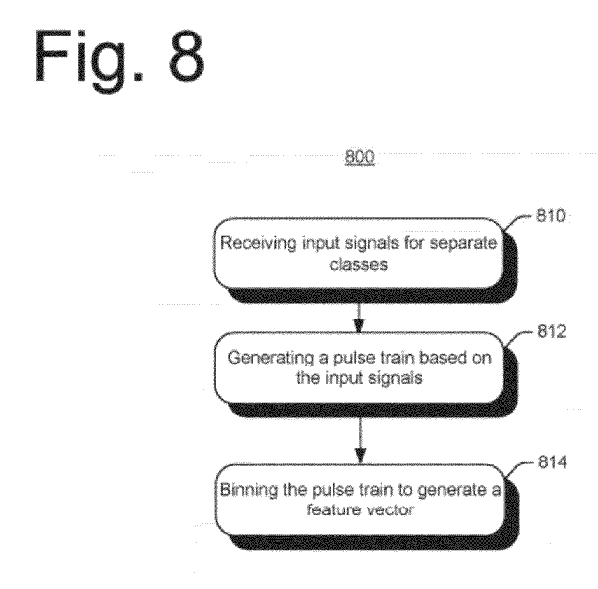

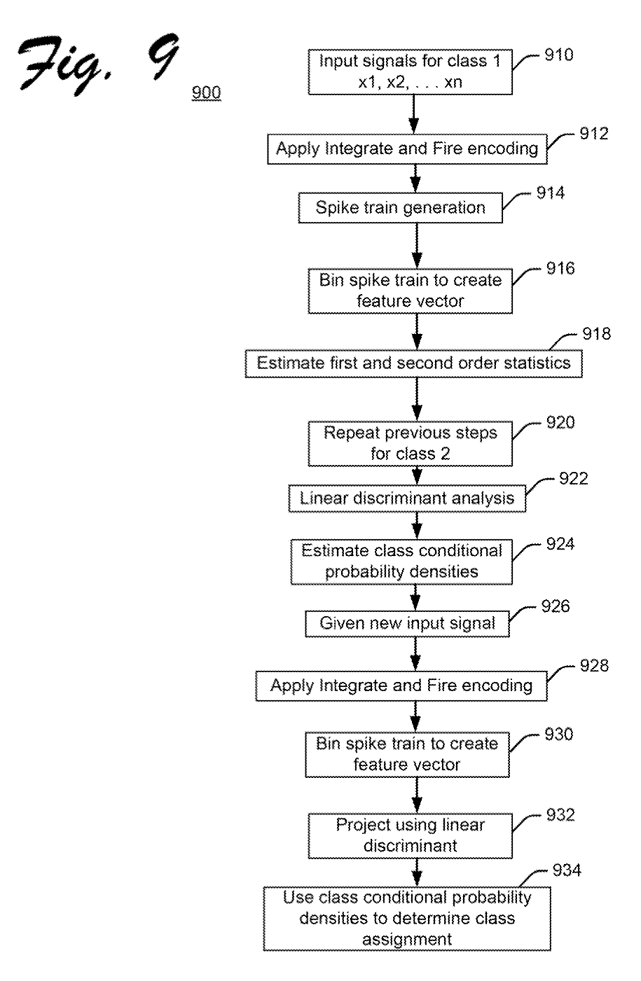

FIGS. 8 and 9 are flowcharts illustrating exemplary operations which may be implemented for time encoding using an integrate and fire sampler. Operations 800 and 900 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used for brokering creative content online.

In FIG. 8, input signals for separate classes are received in operation 810. The separate classes include a first class and a second class. More classes may also be used.

A pulse train is generated based on the input signals in operation 820. The pulse train is binned to generate a feature vector in operation 830. In an example, binning may include dividing the pulse train into equal size bins and counting a number of pulses in each bin.

The operations shown and described herein are provided to illustrate examples. It is noted that the operations are not limited to the ordering shown. Still other operations may also be implemented.

Further operations may also include applying IF encoding to the input signals. Further operations may also include determining at least first and second order statistics, or higher order statistics (e.g., conditional intensity function). Further operations may also include applying discriminate analysis. For example, the discriminant analysis may be linear. Other examples are also contemplated, such as, quadradic discriminant analysis, neural networks, support vector machines, K-NN (nearest neighbors) and other non-parametric statistics based classifiers.

It is also noted that the conditional intensity function CIF is a statistic that enables modeling the behavior of a stoichastic point process. CIF may also be used to estimate the instantaneous probability of a spike given the history of the process. In other words, the point process is represented as a regressive model of order P, or by stepwise statistical methods. So CIF provides a signature of the point process under consideration. The CIF is also referred to as a hazard function in the applied statistics field.

Further operations may also include determining class conditional probability densities. Further operations may also include determining class assignment based on the class conditional probability densities.

In FIG. 9, signals are input for the first class in operation 910. IF encoding is applied in operation 912. A pulse train is generated in operation 914. The pulse train is binned to generate a feature vector in operation 916. The first and second order statistics are estimated in operation 918. Operations 910-918 are then repeated for the second class, as indicated at 920.

Linear discriminate analysis is applied in operation 922. The class conditional probability densities are estimated in operation 924. A new input signal is received in operation 926. IF encoding is applied in operation 928. The pulse train is binned to generate a feature vector in operation 930. Output is projected using a discriminate in operation 932. Class conditional probability densities are determined to determine class assignment in operation 934. Again, FIG. 9 is illustrative of an example only, and is not intended to be limiting either in ordering of the operations, or the number of input streams.

The examples shown and described are provided for purposes of illustration and are not intended to be limiting. Still other examples are also contemplated.

1. A method of time encoding using an integrate and fire (IF) sampler, comprising:
receiving input signals for separate classes;
generating a pulse train based on the input signals; and
binning the pulse train to generate a feature vector.

2. The method of claim 1, wherein the separate classes include at least a first class and a second class.

3. The method of claim 1, further comprising applying IF encoding to the input signals.

4. The method of claim 1, further comprising determining higher order statistics using the feature vector for downstream processing.

5. The method of claim 1, applying discriminant analysis for class separation.

6. The method of claim 5, wherein discriminant analysis is linear.

7. The method of claim 1, further comprising applying at least one of: quadradic discriminant analysis, neural networks, support vector machines, K-NN (nearest neighbors), and other non-parametric statistics based classifiers for class separation.

8. The method of claim 1, further comprising determining class conditional probability densities based on the feature vector.

9. The method of claim 8, further comprising determining class assignment based on a likelihood ratio of the class conditional probability densities of input signal classes.

10. The method of claim 1, wherein binning comprises dividing the pulse train into equal size bins and counting a number of pulses in each bin.

11. A system for time encoding using an integrate and fire (IF) sampler, comprising:
a pulse train generator to generate a pulse train based on the input signals for separate classes; and
a feature vector generator to bin the pulse train and generate a feature vector.

12. The system of claim 11, wherein the separate classes include at least a first class and a second class.

13. The system of claim 11, further comprising an IF encoder to apply IF encoding to the input signals.

14. The system of claim 11, further comprising a statistical analyzer to determine higher order statistics.

15. The system of claim 11, a discriminate analyzer to distinguish class separation of input signals.

16. The system of claim 11, further comprising a class assignment module to determine class assignment based on class conditional probability densities.

17. A system having a computer readable medium and a processor, the processor executing program code for time encoding using an integrate and fire (IF) sampler by:
generating a pulse train based on input signals for separate classes; and
binning the pulse train to generate a feature vector.

18. The system of claim 17, wherein the program code applies IF encoding to the input signals.

19. The system of claim 17, wherein the program code applies discriminate analysis to distinguish class separation of input signals.

20. The system of claim 17, wherein the program code determines a class assignment based on class conditional probability densities.
